(19) United States
(12) Patent Application Publication
(10) Pub. No.: US 2018/0219295 A1
(43) Pub. Date: Aug. 2, 2018

(54) Wideband A-frame Waveguide Probe Antenna

(71) Applicants: Michael Benjamin Griesi, Gilbert, AZ (US); Thomas Anthony McDonough, Columbia, SC (US); Paul Gordon Huray, Georgetown, SC (US)

(72) Inventors: Michael Benjamin Griesi, Gilbert, AZ (US); Thomas Anthony McDonough, Columbia, SC (US); Paul Gordon Huray, Georgetown, SC (US)

(21) Appl. No.: 15/878,414

(22) Filed: Jan. 24, 2018

Related U.S. Application Data
(60) Provisional application No. 62/451,814, filed on Jan. 30, 2017.

(51) Int. Cl. H01Q 13/06; H01Q 13/02

(52) U.S. Cl. CPC H01Q 13/065; H01Q 13/0266; H01Q 13/0225

(57) ABSTRACT

A right-angle waveguide probe antenna with a bandwidth greater than 15% of the center frequency of the operating band, as defined by a return loss over the frequency range better than or equal to −20 dBV. This invention is most relevant to a right-angle coaxial to an air-filled rectangular waveguide transition. The probe antenna is comprised of a flared section followed by a rectangular section resulting in an irregular convex pentagon shape with two right angles at the base which resembles an A-frame on top of a rectangle. The resultant “A-frame probe” can be connected to a coaxial feed cable and extended into a waveguide through an aperture. The A-frame probe operates as a TE10 mode waveguide radiator, and is sized and positioned such that the impedance of the probe antenna is closely matched to the impedance of the waveguide across a wider frequency band.

### CROSS-REFERENCE TO RELATED APPLICATIONS

Provisional Patent: US 62/451,814

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates generally to coaxial to waveguide adapters, and more specifically, to a right-angle coaxial to waveguide probe antenna for transmitting and receiving the dominant TE mode.

### Background of the Invention

Rectangular waveguides excited by a right-angle coaxial to waveguide probe antenna conventionally provide a narrow bandwidth of operation, typically less than 15% when defined by a return loss over the frequency range better than. or equal to −20 dBV. The frequency and/or frequency range of operation is determined by the frequencies at which the impedance of the probe antenna is matched to the impedance of the waveguide [R. Collin, Field Theory of Guided Waves. McGraw-Hill, 1960, pp. 258-271], provided the frequency and/or frequencies are above the cutoff frequency of the waveguide.

A common feature among conventional right-angle coaxial to waveguide probe antennas is a narrow band of frequencies at which the probe antenna impedance is matched, or closely matched, to the impedance of the waveguide. However, in some applications, a larger bandwidth is more desirable. The solution to this problem is not trivial and has, until now, remained elusive. Thus, there exists a need for a wideband coaxial to waveguide probe antenna.

### Background Art

U.S. Pat. No. 4,463,324, patented Jul. 31, 1984 by inventor John C. Rolfs, reveals a miniature coaxial transmission line to waveguide transition that utilizes a metallic cylindrical sleeve affixed to the end of the projecting center conductor. The cited existing art provides a method of matching the antenna probe impedance to operate at a particular frequency but does not provide a method to increase the bandwidth beyond the conventional bandwidth of operation. The limitation of existing art is that the bandwidth is fixed and cannot be increased beyond the conventional bandwidth of operation.

### BRIEF SUMMARY OF THE INVENTION

The following is intended to be a brief summary of the invention and is not intended to limit the scope of the invention.

With the stated background of the invention in mind, it is an object of this invention to provide a right-angle waveguide probe antenna. with a bandwidth greater than 15% of the center frequency of the operating band, defined by a return loss over the frequency range better than or equal to −20 dBV.

This invention is most relevant to a right-angle coaxial to an air-filled rectangular waveguide transition.

The object of this invention is attained generally by designing the shape of the probe antenna such that it is capable of matching, or closely matching, the impedance of the probe antenna to the impedance of the waveguide across a wide band of frequencies.

The embodiment of this invention is characterized by a conducting structure, typically copper, and is formed such that the probe antenna increases in width along the cross-sectional dimension of the waveguide from the diameter of the coaxial feed center conductor to a width greater than the diameter of the coaxial center conductor but less than the width of the waveguide. The exact width of the widest part of the probe antenna will be determined by the desired increase in bandwidth. The flared section will then be followed by a rectangular section to reach the depth necessary to match the impedance of the probe antenna to the impedance of the waveguide across the desired frequency band, resulting in a pentagon shape resembling an A-frame on top of a rectangle. The thickness of the probe antenna will remain equal to the diameter of the coaxial center conductor in the longitudinal dimension of the waveguide. Finally, the probe will be positioned such that the distance to the back wall of the waveguide is set to match the impedance of the probe antenna to the impedance of the waveguide across the desired frequency band. This invention overcomes the narrow bandwidth limitation of existing art by careful inclusion of a flared section and maintaining a uniform thickness in the longitudinal dimension of the waveguide, resulting in a wide bandwidth operation as previously defined.

### BRIEF DESCRIPTION OF THE SEVERAL VIEWS OF THE DRAWING(S)

Note: For simplicity of illustration, any mounting hardware related to affixing a coaxial cable to a rectangular waveguide of common industry hardware are not depicted as they are generally known to those with skill in the art, and more importantly do not impact performance as the hardware is external to the invention disclosed.

FIG. 1 is an isometric drawing of the wideband A-frame waveguide probe antenna, connected to the center conductor of a coaxial feed and positioned within a rectangular waveguide.

FIG. 2 is a top-down view of the wideband A-frame waveguide probe antenna, connected to the center conductor of a coaxial feed and positioned within a rectangular waveguide.

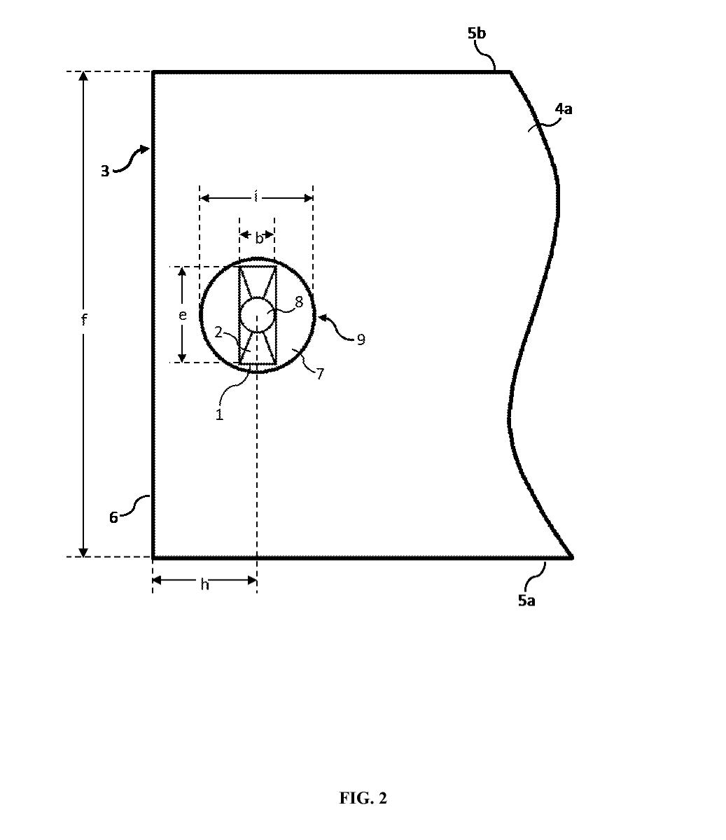

FIG. 3 is a cross-sectional view of a rectangular waveguide with the wideband A-frame waveguide probe antenna connected to the center conductor of a coaxial feed and positioned within the rectangular waveguide.

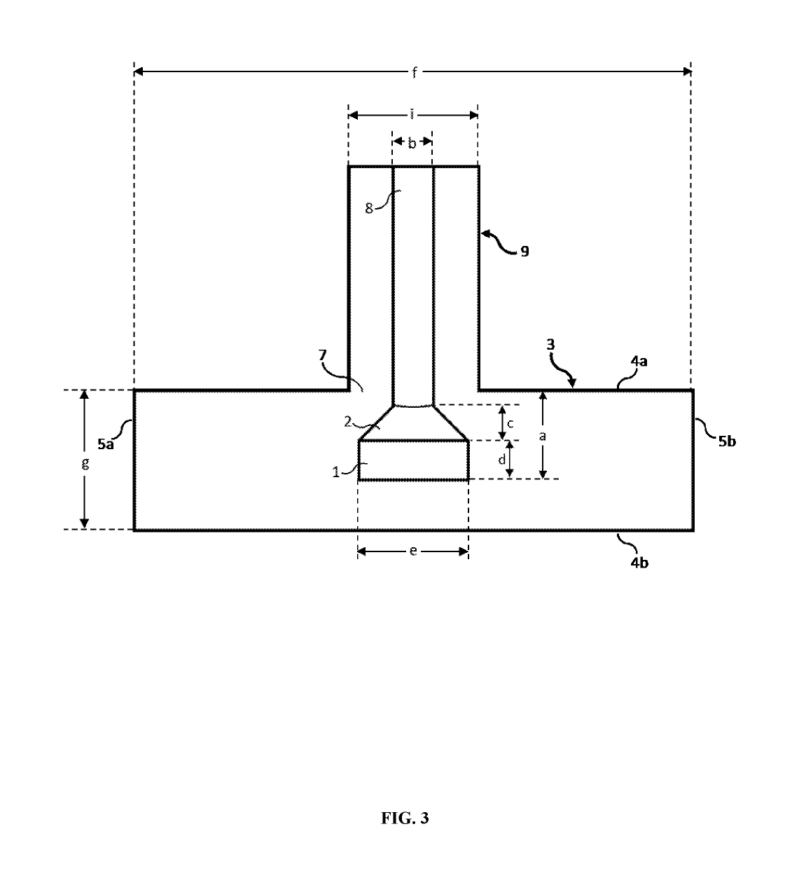

FIG. 4 shows the insertion and return loss performance of a wideband A-frame waveguide probe antenna.

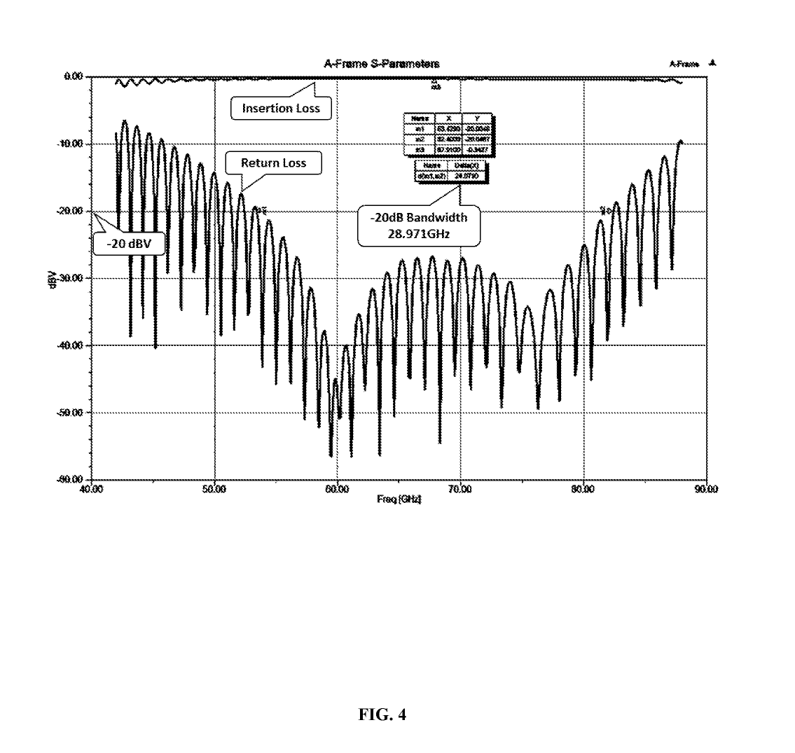

### DETAILED DESCRIPTION OF THE INVENTION

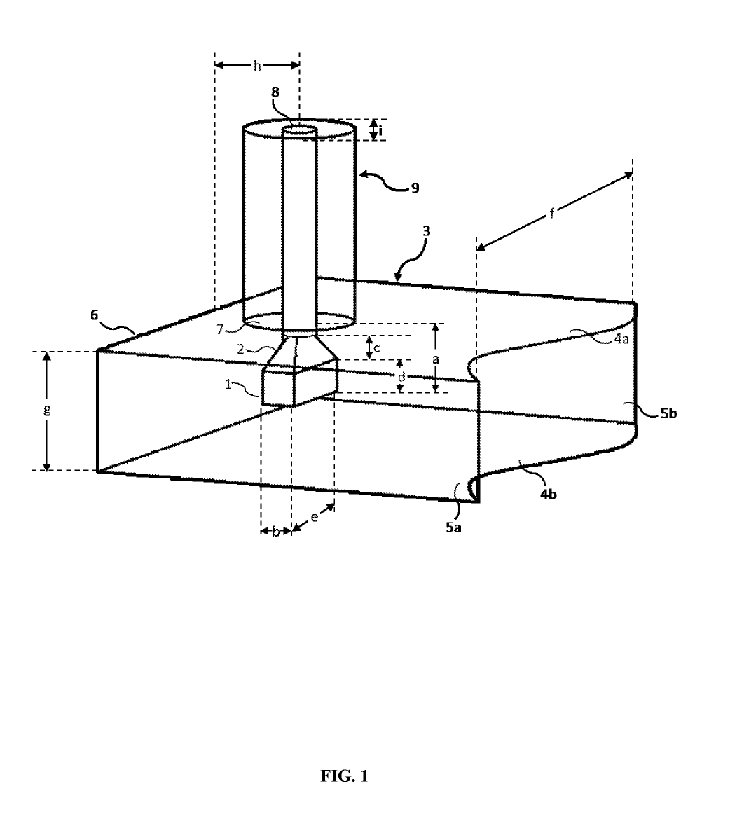

Referring to FIG. 1, a wideband A-frame waveguide probe antenna 1 and 2 (hereinafter sometimes referred to simply as A-frame probe) is shown to include a waveguide section 3 having a pair of broad walls 4a and 4b, a pair of narrow walls 5a and 5b, and a short circuited end (or backshort) 6. The A-frame probe extends into the waveguide section 3, through an aperture 7 in one of the broad walls 4a, and is attached to the center conductor 8 of a coaxial feed cable 9.

The coaxial feed cable 9 is filled with a dielectric material between the inner and out conductors, while the waveguide section 3 is filled with air. The transition between the two materials occurs at the interior broad wall 4a which the aperture 7 is located. The A-frame probe 1-2 and coaxial feed inner conductor 8 are made of copper. The coaxial feed outer conductor and waveguide walls 4a, 4b, 5a, 5b. and 6 are made of aluminum.

The overall length of the A-frame probe is approximately 0.799 mm, as measured from the inside broad wall 4a at the center point of the aperture 7 to the bottom of the rectangular section of the A-frame probe 1.

The thickness of the A-frame probe is approximately 0.36 mm, which is equal to the diameter of this specific embodiment of the center conductor 8 of the coaxial feed cable 9.

The height of the top triangular section of the A-frame probe 2 is approximately 0.31478 mm as measured from the point at which the probe width begins to flare approximately 0.1349 mm below the inside broad wall 4a at the center point of the aperture 7.

The height of the bottom rectangular section of the A-frame probe 1 is approximately 0.34976 mm as measured from the bottom of triangular flared section of the A-frame probe 2.

The narrow width at the top of the triangular section of the A-frame probe 2 is approximately 0.36 mm, which is equal to the thickness of the A-frame probe 1 and the diameter of the center conductor 8 of the coaxial feed cable 9.

The broad width of the rectangular section of the A-frame probe 1 is approximately 0.9924 mm.

The interior of the broad walls 4a and 4b of the waveguide section 3 are approximately 4.997 mm wide and the interior of the narrow walls 5a and 5b are approximately 1.249 mm high.

The center of the A-frame probe 1 and 2 is approximately 1.0818 mm away from the back wall (or backshort) of the waveguide section 6 and in the center of the broad wall 4a dimension.

The diameter of the aperture 7 is approximately 1.152 mm and the relative permittivity of the dielectric within the coaxial cable between the center and outer conductor is 2.08. The outer diameter of the dielectric within the coaxial cable (and coincident inner diameter of the coaxial cable outer conductor) is equal to the diameter of the aperture 7. The characteristic impedance of the coaxial cable is therefore approximately 50 Ohms. The rectangular waveguide is air-filled, and thus has a relative permittivity of 1. This specific embodiment of this invention has demonstrated a bandwidth of up to 46% for a symmetric center frequency across the band of operation of 68 GHz. The resulting 31.3 GHz bandwidth, thus, ranges from approximately 52.3 GHz to 83.6 GHz. In operation, the A-frame probe antenna operates as a TE10 mode waveguide radiator within or across the frequency band of operation.

The dimensions of the A-frame probe just mentioned were:

a=0.799 mm

b=0.36 mm

c=0.31478 mm

d=0.34976 mm

e=0.9924 mm

f=4.997 mm

g=1.249 mm

h=1.0818 mm

i=1.152 mm

Having described a specific embodiment of this invention, it is now evident that other embodiments incorporating its concepts may be used. For example. the antenna element could be fed by an alternative feed network, such as a planar trace. Also, it will be apparent to those skilled in the art that various modifications and variations of the present invention's parameters can be made to achieve differing amounts of bandwidth without departing from the scope or spirit of the invention. Thus, this invention should not be restricted to its disclosed embodiment, but rather it is intended that the present invention covers such modifications and variations as come within the scope of the appended claims and their equivalents.

The invention claimed is:

1. An A-frame right-angle waveguide probe antenna comprising:
a. a flared upper section connected with the narrow end connected to the feed conductor;
b. a rectangular lower section connected to the wide end of the flared upper section;
c. an overall irregular convex pentagon shape resembling an A-frame on top of a rectangle; and
d. a thickness that remains relatively uniform along the longitudinal direction.

2. An A-frame right-angle waveguide probe antenna as recited in claim 1, characterized by a bandwidth greater than 15% of the center frequency of the operating band as defined by a return loss over the frequency range better than or equal to −20 dBV.

3. An A-frame right-angle waveguide probe antenna as recited in claim 1, in which the width or thickness of the flared section is adjustable or otherwise tunable.
